(19) United States
(12) Patent Application Publication
(10) Pub. No.: US 2004/0197455 A1
(43) Pub. Date: Oct. 7, 2004

(54) Extruded starch-based pet chew bodies

(76) Inventors: Li Nie, Kansas City, MO (US); Sukh D. Bassi, Atchison, KS (US); Clodualdo C. Maningat, Platte City, MO (US)

Correspondence Address: LATHROP & GAGE LC, 2345 GRAND AVENUE, SUITE 2800, KANSAS CITY, MO, 64108, US

(21) Appl. No.: 10/755,597

(22) Filed: Jan. 12, 2004

Related U.S. Application Data
(63) Continuation-in-part of application No. 10/284,553, filed on Oct. 30, 2002.

(51) Int. Cl. A21D 10/00

(52) U.S. Cl. 426/549

(57) ABSTRACT

Starch-based extruded bodies are provided which are suitable as long-lasting dog chews, with a typical chew time lasting 10-25 minutes for the dogs. The products contain quantities of starch, plasticizer, and water as essential ingredients and less than about 3% by weight combined fat, lecithin and its derivatives, fatty acids and derivatives. The pet chew has tough yet ductile properties. Preferably the starch comprises gelatinized starch which is capable of physical crosslinking or retrogradation. Preferably, a twin screw extrusion system including a pre-conditioner is used for production of the chews. Extrusion conditions are established so as to ensure adequate moisture content for retrograding the gelatinized starch after processing.

### RELATED APPLICATIONS

This application is a continuation-in-part of application Ser. No. 10/284,553, filed Oct. 30, 2002.

### BACKGROUND OF THE INVENTION

1. Field of the Invention

The present invention relates to extruded starch-based edible products. More particularly, the extruded products and extrusion methods useful in forming the products may provide, for example, long-lasting pet chews.

2. Description of the Related Art

Pet owners are able to choose from a wide variety of commercially available extruded dog foods when selecting formulated diets for their pets. Physical forms of extruded dog foods include, for example, moist, semi-moist and dried kibble-type foods. Extruded starch-based materials that pertain to long-lasting dog chew products are not commercially available. In addition, typical extruded dog foods are designed for immediate consumption once presented to an animal, rather than over an extended period of time.

By way of example, U.S. Pat. No. 4,284,652 discloses producing a matrix from which is formed a soft, dry pet food product. The matrix contains a mixture of starch, fat, polyhydric alcohol and water. The mixture forms a soft, pliable, and stretchable composition that may also contain supplemental protein and other nutritional ingredients. However, the soft product is not suitable for use as a long-lasting dog chew.

A number of starch-based injection molded chew products have various shapes and designs, such as dog biscuits. These products are generally brittle and tend to become slimy when contacted with water. In this context, brittleness is a propensity to shatter when dropped, or readily shear into smaller portions when chewed by a dog, such that a medium sized dog can readily consume one product in less than a minute. Furthermore, these starch-based products tend to dissolve in the dog's saliva, which presents a staining problem should the dog consume the chew indoors in the vicinity of carpet and upholstery.

Copending U.S. patent application Ser. No. 10/284,553, filed Oct. 30, 2002, concerns a longer lasting chew treat product that is made by profile extrusion. Pregelatinized starches capable of retrograding under proper formulation and processing conditions are used to create long lasting chew treat products. With proper formulation, the pre-gelatinized starch retrogrades to increase the toughness of the chew product. The resulting product is a longer-chewing chew treat capable of lasting between 10-25 minutes, which is approximately an ideal chew time for dogs.

The extrudate described in the '553 application is difficult or impossible to reshape after it is initially formed, due to the strong shape-retention memory inherent in the pre-gelatinized starch. The inability to reshape the extrudate is a significant problem in making some products, particularly where it is desired to shape the product having three-dimensional features. Also, it is additionally desirable to improve melt temperature control, such that the melt temperature increases less rapidly in response to extruder screw action. For example, a narrow range of process temperatures combined with the materials' quick temperature response to extruder screw speed makes the process control more demanding.

### SUMMARY OF THE INVENTION

The materials and processing described below address the problems outlined above and advance the art by providing an extrudate that can be formed into any desired shape. Additionally, process control over melt temperature is improved for ease of processing. These advantages may be obtained by mixing formulations to include a combination of pregelatinized starch and granular starch at an effective ratio range for providing longer lasting chew characteristics.

A chew treat body produced in accordance with the instrumentalities described below may contain, for example, respective quantities of pregelatinized starch, granular starch, plasticizer, water, and lubricant as essential ingredients. The optional ingredients that can be incorporated may include palatibility enhancers, dental cleaning ingredients, breath freshening agents, antioxidants, colorants, and essential minerals including calcium, nutrients, and herbs. Furthermore, the body may have low fat content, less than 4% by weight, and preferably less than 3% by weight.

Materials that are mixed and extruded to form the pet chew body may contain between about 50-80% starches by weight, preferably between 55-75% by weight and more preferably between 60-70% by weight. The starches include a mixture of pregelatinized starches and granular starches that are not in a pregelatinized state. The starches may be derived from native or chemically modified sources, for example, as described below. Pregelatinized starch is conventionally produced, for example, though a drum drying process which assures at least 95-100% gelatinization. Pregelatinized starches may be purchased commercially, for example, as Midsol*Pregel-10 produced by MGP Ingredients of Atchison, Kans. One example of how to make a pregelatinized starch is described in U.S. Pat. No. 3,086,890, issued to Sarko, et al. The starch slurry is heated to a temperature from just above boiling to 191° C. (375° F.) and a pressure of about 5 to 140 psi for 1 to 60 minutes. The slurry is then drum-dried at 110°-200° C. (230°-392° F.) for 40-75 seconds, and the resulting sheet is pulverized to a dry, porous, white fluffy powder.

The relative amounts of pregelatinized starch and non-pregelatinized granular starch are controlled by observing a ratio of pregelatinized starch to non-pregelatinized granular starch that is effective for imparting good features and process control and chew characteristics to the chew treat body. This ratio ranges from 3:1 to 1:3, and more preferably from 2.5:1 to 1:2.5 in the formulation used for making the chew treats. Preferred forms of pregelatinized starch include pregelatinized derivatives of wheat starch, corn starch, rice starch, tapioca starch, potato starch, and mixtures thereof. In the case of rice flour, the pregelatinized rice flour can also be used as a weight equivalent to rice starch since the protein content of rice flour is very low.

The pet chew bodies receive favorable chew properties by selection of starches that exhibit retrograding properties under the process conditions, formulation and subsequent storage conditions. Retrograde effects are produced, for example, by heating a mixture that contains a pregelatinized starch followed by slow cooling of the heated mixture or an extended storage period that produces retrograding effects. The pregelatinized starch molecules crystallize or physically crosslink upon cooling and storage, provided a small but sufficient quantity of plasticizer and water is present. While this is primarily a function of the pregelatinized starch component, gelatinization of the non-pregelatinized granular starch component under the process conditions also adds to the overall product strength and appearance. Waxy corn or other chemically modified or derivatized starches are not desirable due to low retrograding capability. Even so, these materials may be incorporated into the formulation up to a certain level, provided the overall products maintain good chewing toughness and, preferably, do not exhibit undesirable slimy characteristics when contacted by water.

Preferred pet chew bodies also contain from about 15-23% by weight plasticizer, more preferably between about 16-22% by weight, and most preferably between about 17-21% by weight. The plasticizer is preferably glycerine, propylene glycol, or mixtures thereof, with glycerine being most preferred. The amount of plasticizer in the formulation is chosen so that the product body stays ductile or pliable at 35% relative humidity and above. The plasticizer also helps control the water activity of the product to prevent microbial activity. Preferably, the final product has a water activity of less than 0.7.

In the past, humectants such as sorbitol, mannitol, sugars, and reducing sugars have been utilized in dog chew formulations for helping the products maintain moisture. The use of such humectants is presently undesirable, though their use is not necessarily proscribed.

Preferred pet chew bodies may contain water, for example, between about 6-15% by weight water, more preferably between 7-14% by weight, and most preferably between 8-13% by weight. Water is a functional element of the final product. It contributes to retrograde activity that may enhance the chew body strength even while the chew body is in storage. The water need not be active water to achieve this benefit.

Preferred pet chew bodies may contain less than 1% by weight of lubricants. Such lubricants help prevent the products from sticking to one another. The lubricants may include, for example, glycerol monostearate, glycerol monolaurate, hydrolyzed lecithin and derivatives, hydrolyzed vegetable oils, magnesium stearate, and calcium stearate. One preferred lubricant is glycerol monostearate.

Preferred pet chew bodies may also contain optional ingredients such as palatibility enhancers, fibers, dental cleaning agents, breath freshening agents, flavoring agents, antioxidants, essential minerals including calcium, nutrients, herbs, and colorants. Palatibility enhancers are used in numerous pet food products to attract the animal to the food item. The palatibility enhancer is preferably selected from the group consisting of meat and poultry broth concentrate or spray-dried powder, liver and liver digest broth concentrate or powder, hydrolyzed proteins, and yeast and yeast extract. One particularly preferred palatibility enhancer is from a liver source. Fibers may include cellulose fiber, wheat bran, and innulin. Dental cleaning agents may include fillers and/or phosphates. Breath-freshening agents may include chlorophyll, mint, parsley, and/or kelp. Flavoring agents may include garlic flavor, meat flavors, cheese flavors, fruit flavors, and smoke flavors. Antioxidants can be both natural and synthetic. Colorants may include both natural and synthetic dyes or pigments including titanium dioxide. It is preferable that such additional ingredients individually comprise less than 5% by weight of the final product.

Methods of forming extruded, self-sustaining comestible bodies include providing a mixture of ingredients as described above and extruding the mixture. Preferred methods also include the step of pre-conditioning the mixture prior to extrusion thereof and the step of cooling the extruded body to room temperature after extrusion thereof.

In more detail, the dry starch component is added to the pre-conditioner apparatus and mixed with quantities of plasticizer, steam and water. A portion of the liquid can be introduced in the barrel. A particularly preferred pre-conditioner is a Wenger DDC model of the type shown in U.S. Pat. Nos. 4,752,139 and 5,161,888, incorporated by reference herein. Preferably, the total amount of steam and water added during the extrusion process is between about 10-20% by weight, and more preferably between 12-18% by weight based on the weight of the powder mixture in the feed being 100%. The melt temperature is easily controlled to the desirable temperature of 80-110 ° C. by adjusting the extruder screw profile and screw speed.

While any type of extrusion apparatus is suitable for use with the invention, it is preferable to use a twin-screw extruder. Preferably the mixture is then passed through one or more insert dies thereby forming extrudate strands. The die(s) may be configured so as to produce an extrudate strand having a particular cross-sectional profile, with examples of simple profiles being rectangular, circular, and club-shaped. The strand thickness is specially chosen depending upon the size of pet ultimately intended to consume the chew product. Preferably the extrudate strand will have a thickness of about ¼ to 1½ inches and more preferably from about ⅜″ to 1 inches. The extrudate can also be in a form of curved up sheet to simulate rawhide looking products. The extrudate is placed on a conveying belt for partial cooling. The reshaping unit or embossing device can be placed between the die exit and conveying belt to reshape the extrudate to create better-defined shape and for three-dimensional features. The extrudate or reshaped strands are cut at the end of conveying belt or reshaping unit, and transferred to a cooler for cooling to room temperature. After exiting the cooler, the products can be packaged in canisters, zip-lock bags or pouches, hot melt sealed bags, etc.

Proper packaging improves the quality of products delivered to the ultimate consumer. Because the preferred plasticizers for use in the invention have limited abilities to hold in moisture, especially in low relative humidity environments, the packaging material preferably provides a sufficient barrier to prevent the product from losing too much moisture too quickly during storage. Excessively rapid moisture loss may cause the product to become brittle, especially in environments having a relative humidity of less than 35%. If moisture is allowed to escape slowly, over a prolonged period of time, the gelatinized starch molecules undergo physical crosslinking, or retrogradation. This crosslinking provides added toughness to the final product thereby giving the dog chew a longer chew time and all the other desirable properties such as low swelling, non-slimy feel. It is preferable that such chew time on average be on the order of about 10-25 minutes for a medium sized dog, such as Beagle, Brittany spaniel or a cocker spaniel. Exemplary packaging material demonstrating good moisture barrier properties may be used as packaging materials with such examples as aluminum-plastic film laminates, PET, PVC, PS, PP thermoforms, PVP based-laminates, PE, PP films, and the like.

One aspect of this application, as claimed below, is an extruded, self-sustaining tough and non-brittle comestible body with long lasting chew time comprising between about 50-80% by weight of at least one starch, between about 15-23% by weight of at least one plasticizer, between about 6-15% by weight water, between about 0.2-1.0% by weight of at least one lubricant, and less than about 4% by weight of at least one fat.

Another aspect of this application, as claimed below, is a method of making a comestible body comprising the steps of mixing ingredients that include between about 50-80% by weight of at least one starch, between about 15-23% by weight of at least one plasticizer, between about 6-15% by weight water, between about 0.2-1.0% by weight of at least one lubricant, and less than about 3% by weight of at least one fat, to form a mixture, processing the mixture by screw extrusion equipment to achieve a melt temperature, extruding the mixture to form an extrudate, and shaping the extrudate to form the comestible body.

### BRIEF DESCRIPTION OF THE DRAWINGS

FIG. 1 shows differential scanning calorimetry (DSC) results that indicate the presence of retrograde starch as a separation peak.

FIG. 2 presents the results of a chew time study representative of average or mode chew times falling in a range of from 10 to 25 minutes.

### DETAILED DESCRIPTION

The following examples set forth preferred extruded, self-sustaining bodies hereof and preferred methods of forming the same. It is to be understood, however, that these examples are provided by way of illustration using preferred methods and materials, and as such should not be unduly construed to limit the scope of the invention.

### EXAMPLE 1

Table 1 illustrates examples of three formulations including a mixture of pregelatinized starch and nongelatinized granular starch.

TABLE 1
FORMULATION EXAMPLES

| | Formulation 1 | Formulation 2 | Formulation 3 |
|---|---|---|---|
| Ingredient | (Parts by wt) | (Parts by wt) | (Parts by wt) |
| Pre- | 34 | 62.4 | 62.4 |
| gelatinized | Midsol* | Midsol pregel-10 | Rice-gel 100** |
| starch/flour | pregel-10 | | |
| Granular | 64.6 | 33.6 | 33.5 |
| starch | Midsol 50 | Midsol 50 | Rice flour RL-100** |
| Palatibility | 0.0 | 3.4 | 3.4 |
| enhancer | | Optimizor*** | Optimizor |
| | | CHX H-base | CHX H-base |
| Glycerol | 0.4 | 0.6 | 0.6 |
| monostearate | | | |
| color | 1 | 0.1 | 0.2 |
| | TiO2 | Annato | Paprika |
| glycerine | 24 | 24 | 24 |
| steam | 7 | 8 | 10 |
| water | 11 | 10 | 8 |

*Midsol is a trademark of MGP Ingredients, Inc.
**supplied by Industrial Food Ingredients.
***Optimizer is a trade mark of Applied Food Biotechnology, Inc.

TABLE 2
EXTRUSION CONDITIONS

| | | Formulation | | |
|---|---|---|---|---|
| | | #1 | #2 | #3 |
| Powder feed rate | lbs/hr | 600 | 600 | 600 |
| Pre-conditioner steam | % of powder feed | 6% | 8% | 10% |
| Glycerine in conditioner | % of powder feed | 22% | 22% | 22% |
| Barrel water addition | % of powder feed | 12% | 10% | 8% |
| Feed zone temperature | ° C. | 49 | 52 | 75 |
| Zone 1 temperature (set) | ° C. | 102 | 50 | 65 |
| Zone 2 temperature (set) | ° C. | 106 | 50 | 65 |
| Zone 3 temperature (set) | ° C. | 121 | 60 | 70 |
| Zone 4 temperature (set) | ° C. | 110 | 60 | 70 |
| Screw speed | rpm | 130 | 130 | 130 |

The above formulation gave three-colored samples including white, annato and paprika. The extrusion work was conducted on a Wenger TX-85 twin screw extruder. There were two die inserts of ½″ concave cube with a pin hole. The conditions of this extrusion run are set forth in Table 2 above.

Upon exiting the extruder, the extrudate strands were conveyed onto a 30 feet long conveying belt with a rotating cutter located at the end of the belt. The extrudate could be reshaped easily with a shaper to add three-dimensional features to the profile. The strands were cut at the end of the belt with a rotating blade cutter. The cut-off pieces were transferred to a cooler for cooling to room temperature. After coming out of the cooler, the products were ready for packaging. The treats turned into tough yet pliable products after storing for more than 3 weeks in a plastic pouch.

It was possible to reshape the cut pieces immediately after cutting and prior to cooling to incorporate three dimensional features of good resolution, for example, to texturize the flat surfaces that were cut, round or taper the edges, or imprint lettering. The inclusion of the right amount of granular starch in the formulation made such operations feasible.

### EXAMPLE 2

Table 3 illustrates examples of formulations where the starch content is 100% pregelatinized starch.

TABLE 3
FORMULATION EXAMPLES

| | Formulation 1 | Formulation 2 | Formulation 2 |
|---|---|---|---|
| Ingredient | (Parts by weight) | (Parts by weight) | (Parts by weight) |
| Midsol | 96 | 96 | 96 |
| Pregel-10* | | | |
| Optimizor | 4 | 4 | 4 |
| CHX H-base** | | | |
| coloring | 0.03 | 0.05 | 0.5 |
| | Chlorophill KK | red 40 al Lake | caramel 602 |
| | (green) | 38% | (caramel) |
| | | (red) | |
| glycerine | 26 | 26 | 26 |
| water | 18 | 18 | 18 |

*Gelatinized wheat starch from Midwest Grain Products, Inc.
**Palatability enhancer from Applied Food Biotechnology, Inc.

The above formulation give three colored samples including green, red and caramel color. The extrusion work was conducted on a Wenger TX-85 twin screw extruder. A powder feed comprising Midsol Pregel-10 and the palatability enhancer was fed to the pre-conditioner where it was mixed with a liquid feed comprising 26 parts glycerin and 18 parts water. The conditions of this extrusion run are set forth in Table 4 below.

TABLE 4
EXTRUSION CONDITIONS

| | | Run 5 |
|---|---|---|
| Powder feed rate | lbs/hr | 700 |
| Pre-conditioner | % of powder feed | 44% |
| liquid** | | |
| Barrel liquid feed** | % of powder feed | 0% |
| Feed zone temperature | ° F. | 75 |
| Zone 1 temperature | ° F. | 102 |
| Zone 2 temperature | ° F. | 106 |
| Zone 3 temperature | ° F. | 121 |
| Zone 4 temperature | ° F. | 110 |
| Zone 5 temperature | ° F. | 116 |
| Number of profile | | 5 (club shape cross-section) |
| inserts | | 4 (square cross-section) |
| | | 3 (penta-star cross-section) |
| Screw speed | rpm | 130 |

**Liquid solution comprises 26 parts glycerin, 18 parts water

Upon exiting the extruder, the extrudates were conveyed onto a 30 foot long conveyor belt with a rotating cutter located at the end of the belt. The cut-off pieces were transferred to a cooler for cooling to room temperature. After coming out of the cooler, the products were ready for packaging. The moisture content in the products varied from 11% -15% by weight. After more than 3 weeks of storing, the treats turned into tough yet pliable products.

Attempts were made to reshape the cut pieces immediately after cutting and prior to cooling to incorporate three dimensional features of good resolution, for example, to texturize the flat surfaces that were cut, round or taper the edges, or imprint lettering. These attempts generally failed or produced unsatisfactory results because the material had a tendency to retain the shape it had upon extrusion and cutting.

### EXAMPLE 3

A chew time study was arranged with Sinclaire Research Center, Inc located at Columbia, Mo., to test the products from Example 2. The following are the testing details:

Treat Information:

Treat sizes: small—red 20 g, club shape cross-section, 7.4 cm length, 2.43 cm² cross-section area.

medium—green 35 g, square cross-section, 7.6 cm length, 3.8 cm² cross-section area.

large—caramel color 65 g, penta-star cross-section, 14.5 cm length,

3.86 cm² cross-section area.

All samples were stored together to facilitate moisture equilibrium and retrograde activity for 3 weeks before testing. Final moisture content in the products was 12.38% by weight.

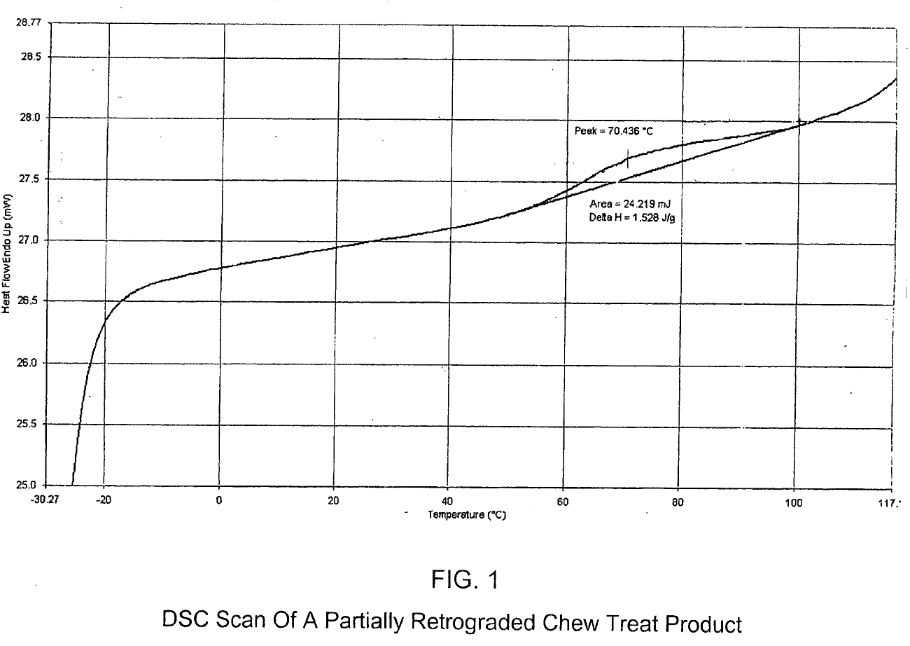

The extent of starch retrograding can be measured and confirmed by the thermal behavior of retrograde starch, as shown in FIG. 1. The peak energy can be measured with a starting temperature of 50° C. to 100° C. at a scanning rate of 10° C./min. The peak energy is a measurement of extra heat needed to melt the irregular crystalline structure of the retrograded starch. The amount of energy, as reported in J/g, is an indication of the extent of retrograding that existed in the product.

Dog Information:

| | |
|---|---|
| Dog size - weight: | small <20 lbs., medium 25-35 lbs., |
| | large 40-55 lbs. |
| Dog size/treat size: | small/small, medium/medium, large/large. |
| Number of dogs used: | 20 dogs. |
| Dog weights: | 19-35 lbs. |
| Ages of dogs: | 1.5-6.1 years, young aggressive ages. |
| Breed of dogs: | beagle and mongrel, the most common dogs |

Testing Protocol:

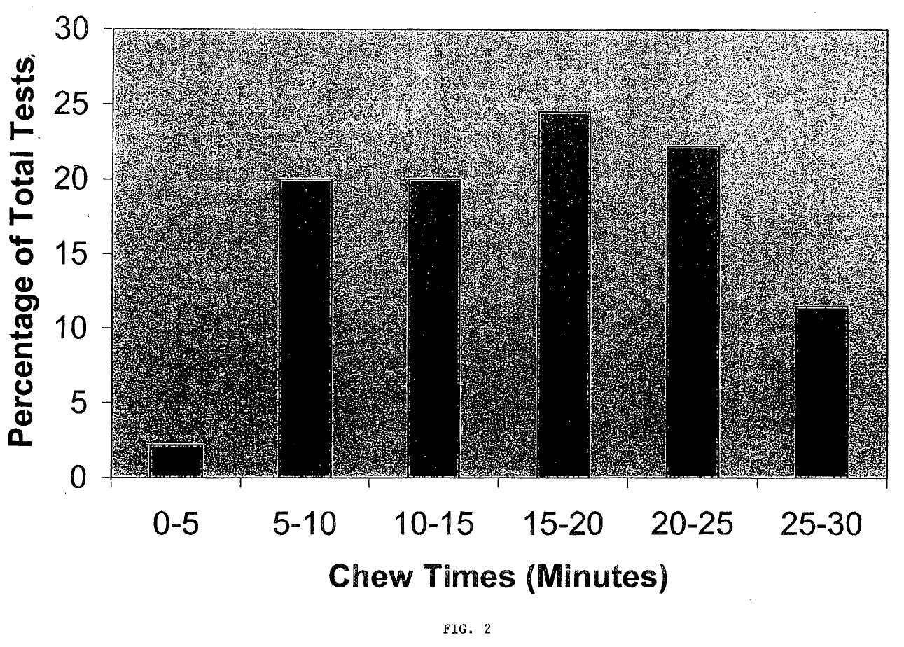

Treats were given every other day, and observations were made to establish cumulative chew time for consumption of the chew body. Three treats were given for each dog one hour before the meal. Before data were collected, all dogs were trained to the treats for one week before formal chew time study was conducted. The dogs were monitored by trained technicians who noted every minute of chew time until the treats were fully consumed or for up to 30 minutes. Chew times of more than 30 minutes were eliminated from the study because it was felt the dog may not have been earnestly attempting to consume the treat. A total of 45 data points were collected from 20 dogs, and FIG. 2 represents the results as a bar graph dividing chew times into six groups of five minutes each shown as a percentage of total chew time allocated to each group.

The data supporting FIG. 2 shows that chew times of from 10-25 minutes are within the standard deviation, as are the mode and arithmetic averages of the individual chew times for each dog. The most likely chew time, i.e., the mode and average values for the data set, fall within 15-20 minutes.

It will be appreciated that the above formulations may be adjusted to vary mode and average chew times to suit different size dogs, where larger dogs tend to consume the chew bodies more rapidly. The water content within the range of from 6-15% by weight may be balanced with the starch content of from 50-80% starches, and the starch content may be further adjusted within a ratio of from 3:1 to 1:3 pregelatinized to granular starch, to achieve these adjustments.

The detailed description of the drawings set forth above and the various compositions and methods described in that detailed description do not, cannot, and are not intended to limit the scope of this application or any patent that issues from this application. The sole measure of the scope of this application is the claims that follow, expanded under the Doctrine of Equivalents where authorized by law.

We claim:

1. An extruded, self-sustaining tough and non-brittle comestible body with long lasting chew time comprising:
between about 50-80% by weight of at least one starch,
between about 15-23% by weight of at least one plasticizer,
between about 6-15% by weight water,
between about 0.2-1.0% of at least one lubricant, and less than about 4% by weight of at least one fat.

2. The body of claim 1, characterized by a property of staying non-brittle at 35% relative humidity and above with no packaging.

3. The body of claim 1, wherein said at least one starch is comprised of partially retrograded pre-gelatinized starches and partially gelatinized starches.

4. The body of claim 3, wherein the relative amount of said pre-gelatinized and partially gelatinized starches ranges from 3:1 to 1:3.

5. The body of claim 3, wherein at least 80% of the pre-gelatinized starches are capable of retrograding.

6. The body of claim 1 where the endothermo peak energy, a measure of the extent of retrograding, is no less than 0.5 J/g as defined from DSC measurement.

7. The body of claim 3, said pre-gelatinized starches being selected from the group consisting of gelatinized wheat starch, corn starch, rice starch, rice flour, tapioca starch, potato starch, acid thinned starches and mixtures thereof.

8. The body of claim 5, further comprising non-retrograding pre-gelatinized starches selected from the group consisting of waxy starch, chemically modified starches including dextrin and maltodextrin, and combinations thereof.

9. The body of claim 1, said at least one plasticizer being selected from the group consisting of glycerin, propylene glycol, and mixtures thereof.

10. The body of claim 9, said at least one plasticizer comprising glycerine.

11. The body of claim 1, said at least one lubricant being selected from the group consisting of glycerol monostearate, glycerol monolaurate, hydrolyzed lecithin and derivatives, hydrolyzed vegetable oils, magnesium stearate, calcium stearate, and mixtures thereof.

12. The body of claim 1, wherein said at least one lubricant is glycerol monostearate.

13. The body of claim 1, further comprising up to 5% palatability enhancer.

14. The body of claim 13, said palatability enhancer being selected from the group consisting of liver, liver digest broth concentrate, liver broth powder, meat broth concentrate, meat broth powder, poultry broth concentrate, poultry broth powder, hydrolyzed proteins, yeast and yeast extract, distillery dry feed, and mixtures thereof.

15. The body of claim 1 further comprising one or more additional ingredients selected from the group consisting of coloring agents, fibers, antioxidants, essential minerals including calcium, nutrients, herbs, flavoring agents, dental cleaning agents, and breath fresheners.

16. The body of claim 15, wherein the additional ingredient comprises the fiber selected from the group consisting of cellulose fiber, wheat bran, innulin, and mixtures thereof.

17. The body of claim 15, wherein the additional ingredient comprises the dental cleaning agent selected from the group consisting of fillers , phosphates, acids, and mixtures thereof.

18. The body of claim 15, wherein the additional ingredient comprises the breath freshening agent selected from the group consisting of chlorophyll mint, parsley, kelp, and mixtures thereof.

19. The body of claim 15, wherein the additional ingredient comprises the flavoring agent selected from the group consisting of garlic flavor, meat flavor, cheese flavor, fruit flavor, smoke flavor, and mixtures thereof.

20. The body of claim 15, wherein the additional ingredient comprises the antioxidant selected from the group consisting of purified natural antioxidants and synthetic antioxidants.

21. The body of claim 15, wherein the additional ingredient comprises the colorant selected from the group consisting of titanium dioxide, natural dye, natural pigment, synthetic dye, and synthetic pigment.

22. The body of claim 15, said additional ingredient or ingredients individually comprising less than 5% by weight of said body.

23. A method of making a comestible body, the method comprising the steps of:
mixing ingredients that include between about 50-80% by weight of at least one starch, between about 15-23% by weight of at least one plasticizer, between about 6-15% by weight water, between about 0.2-1.0% by weight of at least one lubricant, and less than about 3% by weight of at least one fat, to form a mixture;
processing the mixture by screw extrusion equipment to achieve a melt temperature,
extruding the mixture to form an extrudate,
shaping the extrudate to form the comestible body, and
cooling, and packaging the product.

24. The method of claim 23, wherein the mixing step involves the mixing of said at least one starch comprising pregelatinized starch and non-pregelatinized starch and other ingredients.

25. The method of claim 24, wherein the mixing step includes mixing a relative amount of said pregelatinized and non-pregelatinized starch in a ratio that ranges from 3:1 to 1:3.

26. The method of claim 24, wherein the mixing step includes selecting at least 80% of the pre-gelatinized starches to include starches capable of retrograding.

27. The method of claim 23, wherein the melt temperature ranges from 80-110° C.

28. The method of claim 23, wherein the shaping step comprises cutting the extrudate.

29. The method of claim 28, wherein the shaping step further comprises shaping the extrudate by impression after the step of cutting.

30. The method of claim 28, wherein the shaping step further comprises shaping the extrudate by impression before the step of cutting.

31. The method of claim 23, further comprising a step of cooling, packaging, and storing the comestible body for a period of time effective for the starch to retrograde, thereby improving a chew performance characteristic of the comestible body.

32. A comestible body produced according to the method of claim 31, the comestible body being characterized by an ability on average to withstand from 10 to 30 minutes of direct chewing by a medium size dog.

33. A comestible body produced according to the method of claim 28, the comestible body being characterized by an ability on average to withstand from 10 to 30 minutes of direct chewing by a medium size dog.

34. A comestible body produced according to the method of claim 23, the comestible body being characterized by an ability to withstand from 10 to 30 minutes of direct chewing by a medium size dog.
